(19) United States
(12) Patent Application Publication
(10) Pub. No.: US 2025/0206040 A1
(43) Pub. Date: Jun. 26, 2025

(54) METHOD FOR OPERATING A PRINTING PLANT, AND PRINTING PLANT AND COMBINATION CONSISTING OF A PRINTING PLANT OF THIS TYPE AND A CORRUGATED BOARD PLANT

(71) Applicant: BHS Corrugated Maschinen- und Anlagenbau GmbH, Weiherhammer (DE)

(72) Inventors: Eva FRIEDL, Gebenbach (DE); Simon HUBER, Amberg (DE); Christian KLINGER, Wernberg-Köblitz (DE)

(21) Appl. No.: 18/845,553

(22) PCT Filed: Jun. 7, 2023
(86) PCT No.: PCT/EP2023/065304

§ 371 Date: Sep. 10, 2024

(30) Foreign Application Priority Data
Jun. 10, 2022 (DE) 102022205921.2
Mar. 6, 2023 (DE) 102023201976.0

(51) Int. Cl. B41J 11/00

(52) U.S. Cl. CPC B41J 11/00216; B41J 11/0022; B41J 2203/011

(57) ABSTRACT

A method for operating a printing plant (2) is specified, wherein the printing plant (2) has a printing unit (8), for printing a paper web (10) in accordance with a predefined job with predefined job data, wherein the paper web (10) is conveyed at a web speed through the printing plant (2), wherein the printing plant (2) has at least one dryer (18, 20) with an adjustable drying performance, in order to dry the paper web (10), as a result of which the paper web (10) experiences shrinkage, wherein the printing plant (2) has at least one dampener (22) with an adjustable dampening performance, in order to dampen the paper web (10) and, as a result, to adjust a moisture content of the paper web (10), wherein an actual shrinkage and an actual moisture content are determined for the paper web (10), and a setpoint shrinkage and a setpoint moisture content are predefined, wherein the shrinkage and the moisture content are regulated to the setpoint shrinkage and the setpoint moisture content by adjusting the drying performance and the dampening performance which is dependent on the actual shrinkage and the actual moisture content. Furthermore, a printing plant (2) and a combination (6) consisting of a printing plant of this type and a corrugated cardboard plant (4) are specified.

The invention relates to a method for operating a printing plant and to an installation having such a printing plant, optionally in combination with a corrugated cardboard plant.

A printing plant is used to print a paper web with a print image, or print for short. The print and thus also the paper web are regularly dried with a dryer (e.g. hot-air dryer and/or IR dryer), which causes the print and the paper web to shrink and also necessarily removes moisture from the paper web.

A problem during operation is a change in the web speed with which the paper web is conveyed through the printing plant. At different web speeds, the paper web is exposed to the dryer for different lengths of time, so that the shrinkage and moisture content of the paper web change depending on the web speed. This is particularly disadvantageous with regard to the dimensional accuracy of the print and the maintenance of a certain moisture content, e.g. for further processing.

The problem can basically be avoided by simply operating the printing plant at a constant web speed. This is particularly useful for stand-alone operation or roll-to-roll operation, where the paper web is unrolled before the printing plant and rolled up again after the printing plant. However, in a system consisting of a printing plant and at least one other system, i.e. inline operation of the printing plant, a constant web speed may limit the performance of the combination. It is therefore desirable to keep the shrinkage and moisture of the paper web at the output of the printing plant as constant as possible despite varying web speeds.

Against this background, one object of the invention is to enable the most flexible possible operation of a printing plant. For this purpose, an appropriate procedure for operating a printing plant should be specified. Furthermore, a corresponding printing plant and a combination of a printing plant and a corrugated cardboard plant are to be specified.

The object is achieved according to the invention by a method having the features according to claim 1 and by a printing plant or a combination of such a plant and a corrugated cardboard plant having the features according to claim 13. Advantageous embodiments, further developments and variants are the subject of the dependent claims. The statements in connection with the method also apply analogously to the printing plant and the combination, and vice versa. If steps of the method are described below, advantageous embodiments for the printing plant and the combination result from the fact they are designed to carry out one or more of these steps. For this purpose, the printing plant or the combination in particular has a suitably designed control unit.

A core idea of the invention is in particular a control of the dimensional stability of preferably digital printed products taking into account the paper water content, more precisely: a respective regulation of both the shrinkage and the moisture of a paper web which is printed in a printing plant.

The method according to the invention is used to operate a printing plant. The operation is preferably, but not necessarily, an inline operation, i.e. the printing plant is combined with at least one other system to form a combination. The printing plant has a printing unit for printing a paper web according to a specified job with specified job data which define the job (also “print job”). For this purpose, the printing unit has in particular one or more print heads. The printing unit is also called a print chamber. Preferably, the printing plant is a digital printing plant and printing is done using an inkjet method.

The job data of a job are specified in particular by means of a higher-level control unit, e.g. directly by the control unit itself or by an operator who enters the job data into the higher-level control unit, e.g. via an interface (also referred to as visualization) of the higher-level control unit. The higher-level control unit is part of the printing plant or is designed separately from it. The job data contain in particular a production mode in which the printing plant is to be operated, as well as paper web data. The production mode defines in particular a certain print quality, an amount of ink to be printed, whether a primer should be applied before printing, whether a varnish or varnish print should be applied after printing, etc. or a combination of these. The paper web data include in particular a paper type, a paper web grammage, etc. or a combination thereof. In particular, configuration data (also referred to as a recipe) are derived from the job data and suitably contain corresponding machine data for the job-dependent setting of the printing plant. The derivation of the configuration data (lower level) from the job data (higher level) is of secondary importance in this case and is carried out, for example, on the basis of experimentally determined characteristic curves, tables and/or suitable models which are stored, for example, in the higher-level control unit. The configuration data are then passed on to a machine control system of the printing plant in order to adjust and control it accordingly.

The paper web is generally conveyed through the printing plant in a conveying direction at a web speed. Particularly preferred is an embodiment in which the paper web is fed to a corrugated cardboard plant after printing. The corrugated cardboard plant is designed to produce corrugated cardboard and uses the paper web printed by the printing plant, which is combined with other paper webs to form corrugated cardboard. The web speed is determined in particular by the corrugated cardboard plant and varies over time. The web speed typically varies when there is a change of jobs, but can also vary within the same job. Accordingly, the invention described here is particularly suitable for a combination of printing plant and corrugated cardboard plant, which is also assumed hereinafter without restriction of generality.

In the following, the terms “upstream” and “downstream” are used to describe the relative positions of two components with respect to the conveying direction. A component A, which is arranged upstream of a component B, is arranged relative to the latter counter to the conveying direction, i.e. the paper web first passes through component A and then component B. The opposite applies for “downstream.”

The printing plant has at least one dryer with an adjustable drying performance in order to dry the paper web, whereby the paper web and thus also the print experience shrinkage and whereby the paper web in particular also experiences a reduction in moisture. The dryer is generally located downstream of the printing unit. The dryer is also called a pressure dryer. The dryer is in particular an IR dryer (infrared dryer) or a hot air dryer; in the case of multiple dryers, a combination of at least one IR dryer and at least one hot air dryer is advantageously used. In a suitable embodiment, a plurality of IR dryers are arranged downstream of the printing unit, and in turn downstream of these there is a plurality of hot air dryers. The drying performance is specified for example as the temperature (e.g. in ° C.) which the paper web experiences through the dryer, but other measurements are also suitable.

The printing plant further comprises at least one dampener with an adjustable dampening performance in order to dampen the paper web and thereby adjust the moisture content (i.e. paper moisture content) of the paper web and in particular also a swelling (i.e. negative shrinkage and thus generally the shrinkage of the paper web). When dampened, the paper web typically swells and thus the print is enlarged. The dampener is preferably located downstream of the dryer and therefore compensates for moisture loss during drying. The dampener is therefore also called a re-dampener. In a suitable embodiment, the dampener has at least one spray bar which extends transversely to the conveying direction and in particular over an entire width of the paper web and sprays water onto it during operation. The dampening performance is specified, for example, as the amount of water applied to the paper web per unit area (e.g. in ml/m²), but other measurements are also suitable.

As part of the process, an actual shrinkage and an actual moisture content are determined for the paper web and a setpoint shrinkage and a setpoint moisture content are specified and the shrinkage and moisture are regulated by adjusting the drying performance and the dampening performance to the setpoint shrinkage and the setpoint moisture depending on the actual shrinkage and the actual moisture content. In other words, by adjusting the drying and dampening performance, the shrinkage and moisture content are adjusted during operation, in particular continuously.

The setpoint shrinkage and the setpoint moisture (controlled variables) are in particular part of the configuration data and are therefore determined based on the job data or are already contained in the job data itself. The setpoint shrinkage and the setpoint moisture are in particular job specific and are therefore appropriately changed when the job is changed (equivalently: when there is a change to a different job), where the same or similar job data and configuration data are correspondingly used for the same or similar jobs. Preferably, the higher-level control unit specifies the setpoint shrinkage and the setpoint moisture content for each job and transmits these to the machine control system, which then regulates the shrinkage and moisture content and controls the dryer and the dampener for this purpose.

In order to regulate the shrinkage, the actual shrinkage is determined, which indicates how much the paper web has shrunk after drying. The determination of the actual shrinkage is carried out in particular inline. For this purpose, an appropriate sensor is used, which is arranged downstream of the printing unit and in particular also downstream of the dryer and the dampener in order to obtain the most accurate value possible for the shrinkage.

In a preferred embodiment, the actual shrinkage of the paper web is determined by measuring a web width (perpendicular to the conveying direction) of the paper web downstream of the dryer and comparing it with a web width upstream of the printing unit. Alternatively or additionally, the actual shrinkage of the paper web is determined by optically measuring the shrinkage of print image marks on the paper web downstream of the dryer. For example, the above-mentioned sensor is a web width sensor or alternatively an optical camera system (in particular as part of the printing plant), which optically records the print image and the print image marks contained therein and calculates a deviation between the setpoint and actual shrinkage from the job data. An optical measurement with a camera system has the advantage, compared to web width measurement, that the shrinkage of the print image is ascertained directly. In particular, if a large amount of ink is applied to one side of the paper web and a correspondingly strong swelling occurs, a different shrinkage across the entire width of the paper web can be assumed. If shrinkage is only determined indirectly by measuring the web width, these deviations cannot be quantified across the entire width. The actual shrinkage is actually a transverse shrinkage of the paper web, at least when measuring the web width. Since the longitudinal shrinkage of the paper web is regularly less than the transverse shrinkage, it is sufficient to use only the latter for regulation in order to achieve dimensional accuracy of the print in both the transverse and longitudinal directions. The web width before the printing unit is preferably measured analogously with a web width sensor upstream of the printing unit. A web width sensor in each case determines the web width for example by means of web edge detection or a light grid. The two web widths are compared for example by considering a difference between the web widths in relation to the web width before the printing unit. This ratio then indicates the shrinkage in % based on the web width before the printing unit. If the printing plant is followed by another system, the print is conveniently monitored there by means of another sensor, e.g. the print contains a QR code whose dimensions are monitored by the following system. For this purpose, the distance between a plurality of QR codes is conveniently measured on print images arranged next to each other across the working width. The QR codes serve alternatively or additionally as the print marks mentioned above.

Preferably, the actual shrinkage is determined at the end of the printing plant, e.g. immediately before a rewinder for the paper web, or even outside it, e.g. along a transfer line or within a subsequent plant, i.e. when the paper web is not further processed by the printing plant and in particular before, during or after the paper web is/has been transferred to a subsequent plant. By means of a shrinkage controller, the dryer, or more precisely the dryer performance, is now regulated with the setpoint shrinkage as the reference variable and the actual shrinkage as the controlled variable. In this way, the shrinkage that occurs in the printing plant is regulated to the setpoint shrinkage. The shrinkage controller is in particular a part of the printing plant, in particular the machine control system, and is preferably implemented by means of a programmable logic controller (PLC).

In an advantageous embodiment, the actual shrinkage is standardly determined with a first sensor which is arranged downstream of the printing unit and, as described, at the end of the printing plant, except in the case of a splice, in which case the actual shrinkage is determined with a second sensor which is arranged upstream of the first sensor and which is thus closer to the printing unit. This advantageously reduces the web path from the printing unit to the sensor by a factor of 5 to 20, e.g. from 250 m to just 20 m. In a splice, a new paper web is added to the end of a paper web that is currently in use, which new web may have different properties and lead to different job data. In this case, it is advantageous to reduce the web path for the regulation of the shrinkage as much as possible in order to obtain a faster response of the regulation. It is then accepted that the regulation then no longer takes into account the entire processing of the paper web downstream of the printing unit. After a specified time, or after a specified length of paper web has run through, the first sensor is used again. If necessary, an offset is also taken into account. For example, the first sensor is located downstream of the printing unit, in front of a varnish dryer, and there also before two of three spray bars. The shrinkage due to drying and the swelling caused by the spray bars cause a change in the dimensions of the paper web by a factor x, depending on the settings, possibly with certain tolerances. Based on empirical values, the offset is then used to estimate or assume the further change in shrinkage downstream in favor of the shorter control path resulting from the above-mentioned arrangement. The actual shrinkage is therefore the sum of a measured shrinkage value and the offset, in particular depending on the machine settings downstream. The offset is therefore generally used in particular to correct the actual shrinkage due to the arrangement of the sensor relative to the components that influence the shrinkage.

In order to regulate the moisture content, the actual moisture content is determined analogously to the shrinkage, which indicates how moist the paper web is after dampening. The determination of the actual moisture content is carried out in particular inline. For this purpose, an appropriate sensor is used, which is arranged downstream of the printing unit and also downstream of the dampener. In a suitable embodiment, the sensor is a microwave moisture sensor. The sensor is expediently calibrated for paper webs with different paper properties (paper type, grammage, etc.), e.g. by means of a relevant characteristic curve. Analogous to the measurement of the actual shrinkage, the actual moisture content is preferably determined at the end of the printing plant or even outside of it. The dampener, or more precisely the dampener performance, is then regulated by a moisture controller with the setpoint moisture content as the reference variable and the actual moisture as the controlled variable.

In principle, it is conceivable to simply operate the printing plant at a maximum web speed in order to produce with maximum performance. However, a variable web speed is necessary, at least in inline operation, due to the typically frequent jumps in web speed on the other plant (in particular the corrugated cardboard plant). For example, the web speed is briefly reduced during various quality changes (e.g. cut length changes). In contrast, the web speed is reduced for a long time, for example for certain qualities for which only lower web speeds are possible (e.g. continuous corrugated cardboard at 200-250 m/min). By changing the web speed, the dwell time in the heating and drawing section (i.e. double facer) is also regularly shortened or lengthened in order to eliminate quality problems, such as warp (bending of the corrugated cardboard) and gluing problems. In general and if there are other problems, the web speed is sometimes reduced, e.g. if the paper quality is poor or if a tray at the end of the plant is full. Regardless of the specific reason, a shutdown of the plant always means that the paper remains in the heating and drawing section and is therefore rejected. If the combination were then to be operated at a constant web speed, corresponding rejects would be generated at a reduced web speed because of excessive shrinkage and too-low moisture content. Accordingly, for the various qualities that can be set, additional alternative machine and print settings for a reduced web speed would have to be stored, which means increased effort. In addition, flexible operation specifically for controlling corrugated cardboard quality would also no longer be possible.

In the present case, it was recognized that regulating both shrinkage and moisture is particularly advantageous for the successful inline operation of a printing plant. Without such regulation, the shrinkage and moisture content vary greatly depending on the regularly variable web speed of the other plant, which is taken over by the printing plant. The regulation of shrinkage and moisture described here also enables a job change (i.e. changing the job data) without stopping the printing plant, i.e. during operation. The necessary adjustments to avoid varying shrinkage and moisture due to changed job data are automatically implemented by the regulation. This makes the printing plant particularly flexible to use. Without such active regulation, every job change would require the printing plant to stop, as otherwise the further processing quality of the paper web would be poor.

Investigations have shown that shrinkage and moisture content are strongly dependent on the web speed (equivalent: drying time). In contrast to roll-to-roll operation, it is usually not possible to keep the web speed constant in inline operation. This means that constant shrinkage and sufficient moisture content cannot necessarily be maintained with constant drying and dampening performance. A fluctuation in shrinkage and moisture content, i.e. in the quality of the printed paper web, then regularly leads to further processing problems and quality problems in the subsequent plants, e.g. a corrugated cardboard plant. For example, too little moisture can result in poor gluing or warping. A print image that is too large or too small leads to problems in the further processing of the paper web and specifically the corrugated cardboard made from it. For example, shrinkage that varies during operation regularly leads to problems on a cutting and creasing machine and on the cross cutter of the corrugated cardboard plant, as these have to readjust to any changes in length and width. The result is often an incorrect cut, which means that the print image on the finished corrugated cardboard is no longer positioned correctly.

As part of a study, the actual shrinkage and the actual moisture were recorded over a longer period of time and the relationships between job data (paper type, grammage, production mode (i.e. with/without varnish, with/without primer)), web speed, drying performance and dampening performance were derived from the measured values obtained. On this basis, it was recognized that a regulation of the drying and dampening based on moisture alone or shrinkage alone is possible in principle, but regularly leads to unsatisfactory results. Therefore, the two variables “shrinkage” and “moisture content” are regulated in combination in order to ensure both a dimensionally accurate print image and sufficient moisture content over a wide range of different job data and over a wide web speed range.

Preferably, the drying and dampening performance are regulated such that the shrinkage is kept constant and the moisture content is kept greater than or equal to a minimum moisture content. This is particularly observed in inline operation and at variable web speeds, both within the same job (i.e. with constant job data) and with varying job data. In this case, constant shrinkage and sufficient moisture content are achieved by regulating the drying performance and the dampening performance. Another advantage is that the fluctuations in shrinkage and moisture are as small as possible, i.e. the dynamics of the two controlled variables are as small as possible. Preferably, the shrinkage is regulated such that the actual shrinkage is within a tolerance range around the setpoint shrinkage (e.g. −/−0.5% to −/−1% of the setpoint shrinkage or −/−0.05% of the total width of the paper web or −/−1 to 2 mm in the direction of the total width). If the tolerance range is exceeded, a warning is expediently issued. The tolerance range is specified in particular as part of the job data and, for example, depending on the accuracy required for printing, by means of the higher-level control unit. Analogously, an offset for the setpoint shrinkage is optionally specified and taken into account if required. The moisture is preferably regulated such that the actual moisture corresponds to at least a minimum moisture, e.g. 5%. The minimum moisture content is specified analogously to the tolerance range, preferably by means of the higher-level control unit. If the minimum moisture content is not reached, a warning is expediently issued or the dampening performance is increased, in particular up to a maximum value dependent on the paper type and grammage, and then a warning is issued in particular if the dampening performance cannot be increased any further. This is based in particular on the observation that if the moisture content is too high, i.e. if there is too much dampening, a good quality winding of the paper web is no longer possible. Visually, this is regularly noticeable with a diamond pattern/waves on the rolled-up paper web.

Preferably, the shrinkage regulation is limited by a minimum value for the dryer performance, so that a minimum level of drying is ensured. The drying performance is therefore not reduced arbitrarily in order to reduce shrinkage, but the reduction in drying performance is limited to a minimum performance by the minimum value. The minimum value is appropriately dependent on the web speed and in particular on the amount of ink applied and, optionally, also on the job data. A small amount of ink usually requires a small amount of drying and, conversely, a large amount of ink requires a large amount of drying. In addition, ink usually dries less well on coated paper than on uncoated paper. Preferably, the regulation is set in such a way that sufficient drying is guaranteed at any web speed up to a certain ink application quantity. For jobs with very little ink, the drying may then be too strong, but this is accepted. Advantageously, however, a differentiation is made with regard to the amount of ink applied, in particular in order to save energy by avoiding unnecessary drying. For example, the relationship between web speed and minimum value is stored as a characteristic curve.

When creating new job data, especially prior to carrying out the procedure described here, empirical values or test results are used for the corresponding setpoint shrinkage, or alternatively the setpoint shrinkage is determined in a defined printing process. This setpoint shrinkage is then expediently used as a start value for an iterative optimization, which in a suitable design is carried out as part of the method and thus during operation, or alternatively outside of it.

Optionally, in addition to the previously mentioned components printing unit, dryer and dampener, the printing plant also has one or more additional components, which are used in particular to implement different production modes and/or further support drying and/or dampening.

In a suitable embodiment, the printing plant has a primer application unit for applying a primer to the paper web. The primer application unit is located upstream of the printing unit so that the primer is applied before printing. The primer provides a base coat for the subsequent printing. Due to the primer application unit, the printing plant now has production modes with and without primer (application). Downstream of the primer application unit and upstream of the printing unit, the printing plant preferably has at least one dryer, also referred to as a primer dryer, for drying the primer. This dryer is in particular only active in jobs that include primer application. The dryer is preferably a hot air dryer. In a practical embodiment, one or more (e.g. two) dampeners are additionally arranged downstream of the primer dryer.

Alternatively or additionally, the printing plant has a varnish application unit for the full-surface application of a varnish (i.e. for varnishing) onto the paper web. The varnish application unit is arranged downstream of the printing unit so that the varnish is applied after printing and thus over the print. The varnish represents a surface finish. Thanks to the varnish application unit, the printing plant now has production modes with and without varnish application. Downstream of the varnish application unit and upstream of the printing unit, the printing plant preferably has at least one dryer, also referred to as a varnish dryer, for drying the varnish. This dryer is in particular only active in jobs that include varnish application. The varnish dryer is preferably a hot air dryer. A dampener is expediently arranged upstream of the varnish application unit. Alternatively or additionally, a dampener is expediently arranged downstream of the varnish dryer.

Alternatively or additionally, the printing plant comprises a varnish printing unit, in particular a digital printing unit for varnish, for printing a varnish (i.e. for varnish printing, so-called “digital varnish”) onto the paper web. The varnish printing unit is arranged in particular downstream of the printing unit so that the varnish is printed after printing and thus over the printing. Preferably, the varnish printing unit is also arranged downstream of the varnish application unit, if one is present. The varnish represents a surface finish. Thanks to the varnish printing unit, the printing plant now has production modes with and without varnish printing. Downstream of the varnish printing unit, the printing plant preferably has at least one dryer, also referred to as a varnish printing dryer, for drying the varnish. This dryer is in particular only active in jobs that include varnish printing. Preferably, a plurality of IR dryers and a plurality of hot air dryers are arranged analogously to the printing unit. Expediently, a dampener is arranged downstream of the varnish printing unit and in particular also downstream of the varnish printing dryer.

One or more of the above-mentioned dampeners are preferably used for the moisture content regulation described above and are designed accordingly, for example, as spray bars.

In particular, the primer dryer, the varnish dryer, and the varnish print dryer are not used in the regulation, but are activated or deactivated independently thereof, depending on the required production mode. However, if one or more of these dryers are active, there will be increased shrinkage and reduced moisture content, which is automatically compensated for by the regulation system. In principle, however, the use of one or more of these dryers in regulating shrinkage is also possible and advantageous, in particular in order to increase the regulating range for shrinkage and moisture content accessible by the regulation. In an advantageous embodiment, one or more of the dryers mentioned are accordingly integrated into the regulation system. For example, the varnish printing dryer is used as a booster to further readjust the system. Alternatively or additionally, the primer dryer has both a hot air dryer and an IR dryer. The integration into the regulation system is such that the hot air dryer provides a base load for the drying performance and the IR dryer is only activated during a control peak, i.e. when there is a temporarily increased demand for drying performance.

The web width sensor described above for measuring the web width in front of the printing unit is expediently arranged downstream of the primer application unit and in particular also downstream of the primer dryer. Downstream of the printing unit, the web width is measured at one or more measuring points as described above, in each case expediently by means of a web width sensor. A first suitable measuring point is located downstream of the dryer after the printing unit and upstream of the varnish application unit. A second suitable measuring point is located between the varnish application unit and the varnish printing unit, in particular also downstream of the varnish dryer. A third suitable measuring point is located at the end of the printing plant and—if present—downstream of the varnish printing unit and in particular also downstream of the varnish printing dryer. The first and second measuring points are particularly suitable for the arrangement of the second sensor described above, which is used to determine the actual shrinkage in the case of a splice. The third measuring point, on the other hand, is particularly suitable for the arrangement of the first sensor described above, with which the actual shrinkage is determined as standard.

The setpoint shrinkage is optimally determined (i.e. set) in particular when the maximum drying performance of the dryer and the dampening performance of the dampener required for drying the ink are set by the regulation at maximum web speed (e.g. 300 m/min). This maximum required drying performance and dampening performance does not necessarily correspond to 100% of the available performance in each case; rather, due to paper-specific shrinkage differences, an upward regulating buffer is expediently provided in order to be able to compensate for differences with overdrying. The same applies when using a plurality of dryers and/or a plurality of dampeners for the control of each of these dryers and/or dampeners individually. In exceptional cases, a shift in the optimal setting can bring advantages, optionally in combination with restrictions (possibly a smaller range for the web speed or job change not possible without stopping). For example, as in the case described above, all job changes can be carried out (within certain physical limits). At some point, however, no additional dryer/dampener can be switched on or off. However, if the jobs are limited and only cover a portion of all basically conceivable jobs, e.g. no job with primer, only a few jobs with additional coating and a large number of jobs with varnish, the setpoint shrinkage for the jobs without additional coating is expediently set higher. Although this has the disadvantage of greater energy consumption for these special jobs, it has the advantage that more drying can be switched off in order to compensate for the heating up of the varnish dryer, i.e. a larger process window results. Similarly, for other job changes, it is also useful to optimize which type of job is carried out more frequently. If more/less drying is required to achieve the setpoint shrinkage at the maximum web speed, this must be reduced/increased for future jobs. This is conveniently done automatically by the higher-level control unit, which is then self-learning in this sense. For a new job (e.g. new paper type, grammage), it is appropriate to start with an empirical approximation value for the setpoint shrinkage. If, for example, the new paper type already has a setpoint shrinkage for the grammages 100 g/m² and 200 g/m², a first value for the setpoint shrinkage is assumed based on this, e.g. for 150 g/m², e.g. is simply interpolated.

A particular challenge for the regulation system is presented by rapid changes in web speed, especially when the web path between the printing unit and the sensor for determining the actual shrinkage is long, e.g. because the actual shrinkage is only determined at the end of the printing plant or even outside of it. It is therefore expedient to store start values for the drying performance and the dampening performance for each of a plurality of intervals of the web speed (e.g. as part of the job data) and when the web speed changes from a first interval to a second interval, the start values for the second interval are set first and then the shrinkage and moisture content are regulated based on these. Thus, if the web speed is changed so much that it falls into a different interval with different start values, these start values are set in order to avoid having to wait for the regulation, and to react better. The start values at the start of a job are preferably also improved iteratively for the existing job data. In the case of a constant job, the start value always corresponds to the last start value used at this web speed (e.g. determined as a moving average of the last x productions). If quality remains constant within a job, the last settings for each web speed range or interval are suitably stored temporarily. If a plurality of changes in the web speed occur within a short period of time, the system starts again with the last value for this web speed range or interval and not with an empirical average value. This is based on the consideration that different batches of the same paper type behave differently to a certain extent, particularly with regard to shrinkage. This avoids the initial adjustment having to be carried out every time the web speed changes.

In the event of a large change in the setpoint shrinkage, e.g. in the event of a corresponding job change, it is expedient to proceed similarly as for the web speed. In a suitable embodiment for this purpose, if the setpoint shrinkage changes by a value which exceeds a predefined limit, the drying performance and the dampening performance are changed once (i.e. initially when the setpoint shrinkage is changed) by a predefined value in each case, and then the shrinkage and the moisture content are regulated based on this. In this way, the regulation system is initially supported in adapting to the suddenly new setpoint shrinkage. Below the limit (i.e. when the change is only small), such support is not required and the change is fully compensated by the regulation system. The limit value is typically chosen to be large and is, for example, 0.2% of the total width of the paper web, i.e. the setpoint shrinkage changes by at least 0.2% of the total width of the paper web. The limit value can be defined absolutely or can be defined relative, for example, to the total width of the paper web or to the setpoint shrinkage itself.

Another advantageous embodiment is one in which the regulation system is relieved by specifying a compensation factor already predefined in the job data in order to print the print larger than the setpoint dimension, so that a certain degree of shrinkage is permitted and does not have to be compensated for by the regulation system. This is based in particular on the consideration that shrinkage cannot actually be completely compensated for physically, since shrinkage always consists of a reversible and an irreversible component (hornification of the paper fibers during drying). The print is therefore deliberately enlarged and then shrinks to the setpoint size due to shrinkage in the printing plant. The regulation then advantageously only or at least predominantly only compensates for dynamic changes in the web speed and/or paper-specific differences in the shrinkage. For example, a paper machine is 9 m to 12 mm wide and the paper web produced by it is divided into a plurality of rolls. In rolls from the center of the paper web, the paper fibers are more strongly aligned in the direction of the paper web than in rolls from the edge. Depending on the fiber orientation, the paper webs in each case shrink and swell to different degrees during processing in the plant. Dampening relieves residual stresses resulting from the paper manufacturing process. Depending on the amount of these as it were frozen residual stresses, the paper web swells to varying degrees when moistened. These differences can be up to −/−0.15%. The printing unit prints the print larger by an amount corresponding to the compensation factor. The compensation factor ultimately shifts the starting conditions for the regulation depending on the job, with the aim of accommodating the regulation. The compensation factor is, for example, ascertained in advance through experiments and/or optimized during operation through repeated adjustment. The compensation factor is preferably dependent on the other job data, e.g. paper type, grammage, production mode (with/without primer, varnish, varnish printing). The compensation factor is to be used or adjusted in particular if the tolerance range for shrinkage or minimum moisture content cannot be maintained for given job data. This is particularly advantageous for very high ink application quantities for printing or for jobs where a primer, varnish, or varnish print is used. Since one or more additional dryers are active in this case, a correspondingly changed shrinkage must be taken into account. This is conveniently done by means of the compensation factor for jobs with corresponding job data.

Since the job data for the new job are usually already known when there is a change of job while the current job is still being processed, it is possible and advantageous to use the job data of the new job for predictive controlling of the dryers and/or dampeners. Especially when the new job contains a change in quality and, in contrast to the current job, requires an additional coating, in particular a primer, varnish and/or varnish print, a dryer for this coating, i.e. the primer dryer, the varnish dryer or the varnish print dryer, is expediently preheated during the current job (and, expediently, disruptive influences of the additional dryer are automatically compensated for by changing the dryer performance and the dampener performance) so that the required drying performance is fully or at least largely available when the new job begins. The resulting increased shrinkage and reduced moisture content during the current application is automatically compensated for by the regulation system. Preferably, when a predefined temperature, e.g. 80° C., is exceeded, the regulating range for shrinkage and/or moisture content is increased. If, for example, varnish drying is also active, it is advantageous to reduce ink drying more than otherwise. In this case, the print image may not be completely dried by the ink drying alone, but the active varnish drying subsequently dries the print image accordingly, so that complete drying is guaranteed. With the primer dryer, however, it is exactly the other way around. Because the shrinkage occurs before printing, the print image can no longer shrink as much, so more drying is required here to achieve the same setpoint shrinkage. However, such a degree of additional drying is otherwise blocked below the given temperature (e.g. the mentioned 80° C.). In particular, the tolerances and the minimum moisture content remain unaffected by this. It is advantageous to give priority to jobs with large tolerances or paper types with heavy grammage (smaller shrinkage differences) during changeover times.

In an advantageous embodiment, the dryer is a hot air dryer and the printing plant additionally has an IR dryer to dry the paper web. In other words, the drying performance, which is set by the regulation system to control the shrinkage, is provided by a combination of an IR dryer and a hot air dryer. The IR dryer advantageously has a faster reaction time than the hot air dryer, but is less economical to operate. Preferably, if the regulation system requests an increase in drying performance, e.g. in the event of a job change with a corresponding change in the job data, the IR dryer is activated as a substitute during a heating phase of the hot air dryer in order to meet this request. If, for example, the hot air dryer is below a certain temperature, when the temperature needs to be increased the IR dryer will be used as a substitute until the hot air dryer has heated up. The described procedure is particularly advantageous if the current job specifies a slow web speed, due to which the drying performance is regulated downward to reduce shrinkage and increase moisture content. When the web speed is increased, the IR dryer initially compensates for the reduced drying performance of the hot air dryer until this dryer has again reached the required drying performance.

In some cases it is advantageously possible to increase the range of possible web speeds by pre-drying the paper web before printing. Therefore, in a suitable design, the printing plant has a pre-dryer to pre-dry the paper web before printing. The primer dryer described above is particularly suitable as a pre-dryer, which can then also be activated for pre-drying if needed, even though no primer is applied. Irrespective of this, the pre-dryer is expediently permanently active in order to avoid heating and cooling times. Pre-drying causes in particular a pre-shrinkage of the paper web. Depending on the grammage, etc., each type of paper has a maximum shrinkage at which the paper web contains hardly any water. It is expedient to achieve this maximum shrinkage, because the paper web can then no longer shrink. In this state of maximum shrinkage, the paper web is then printed and the drying time, which varies depending on the web speed, no longer has any influence on the shrinkage. All that is then required is to ensure that sufficient moisture is reintroduced into the paper web through dampening and that the resulting swelling is monitored and, in particular, kept constant. Pre-drying is useful in particular when heat is available at low cost.

In the following, exemplary embodiments of the invention are explained in more detail with reference to a drawing. In the figures:

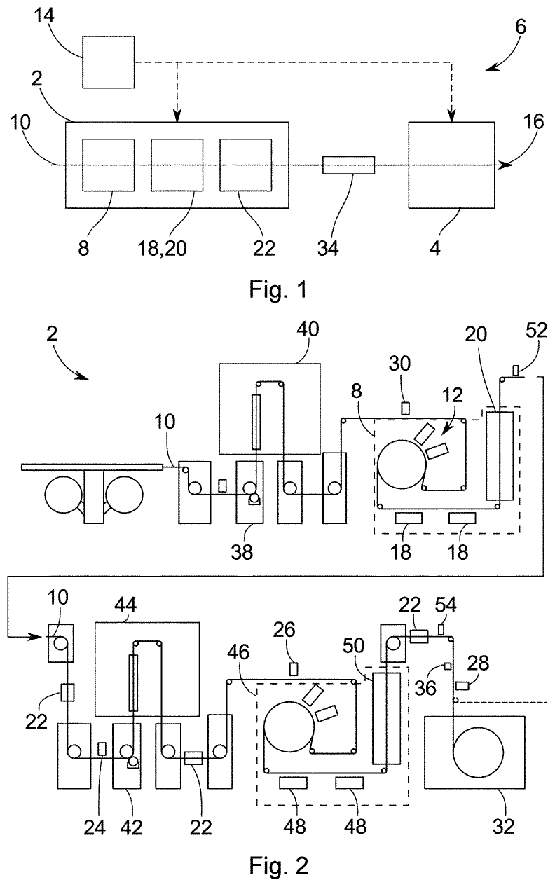

FIG. 1 schematically shows a combination of a printing plant and a corrugated cardboard plant,

FIG. 2 a printing plant in detail.

FIG. 1 schematically shows a printing plant 2 and a corrugated cardboard plant 4, which together form a combination 6. FIG. 2 shows a detailed exemplary embodiment of the printing plant 2, here a digital printing plant for printing using an inkjet method. The printing plant 2 in FIG. 2 is shown in roll-to-roll operation, but is also suitable for inline operation and specifically for use in a combination 6 as shown in FIG. 1.

The printing plant 2 has a printing unit 8 for printing a paper web 10 according to a predefined job with predefined job data which define the job. For this purpose, the printing unit 8 has one or more print heads 12. In FIG. 1, the printing plant 2 is shown in inline operation, whereas in FIG. 2 it is shown in roll-to-roll operation.

The job data of a respective job are specified by means of a higher-level control unit 14, e.g. directly by the control unit itself or by an operator who enters the job data into the higher-level control unit 14, e.g. via an interface of the control unit. The higher-level control unit 14 is designed separately from the printing plant 2 in FIG. 1, but in an alternative (not shown) it is part of it. The job data contain a production mode in which printing plant 2 is to be operated, as well as paper web data. The production mode defines, for example, a certain print quality, an amount of ink to be printed, whether a primer should be applied before printing, whether a varnish or varnish print should be applied after printing, etc. or a combination of these. The paper web data include, for example, a paper type, a paper web grammage, etc., or a combination thereof. From the job data, configuration data are derived which contain corresponding machine data for the job-dependent setting of the printing plant 2 and are forwarded to a machine controller (not explicitly shown) of the printing plant 2.

The paper web 10 is generally conveyed in a conveying direction at a web speed through the printing plant 2 and, in FIG. 1, is fed to the corrugated cardboard plant 4 after printing. The corrugated cardboard plant 4 is designed to produce corrugated cardboard 16 and uses the paper web 10 printed by the printing plant 2, which web is combined with other paper webs to form the corrugated cardboard 16. In the exemplary embodiment shown, the web speed is predefined by the corrugated cardboard plant 4 and varies over time. In an alternative embodiment, instead of the corrugated cardboard plant 4, another system is arranged which further processes the printed paper web 10.

In the following, the terms “upstream” and “downstream” are used to describe the relative positions of two components with respect to the conveying direction.

The printing plant 2 has at least one dryer 18, 20 with an adjustable drying performance in order to dry the paper web 10, whereby the paper web 10 and thus also the print experience a shrinkage. The dryer 18, 20 is always arranged downstream of the printing unit 8 and is also referred to as a printing dryer. In the exemplary embodiment of FIG. 2, a total of six dryers 18, 20 are used, namely four IR dryers 18 and two hot air dryers 20.

The printing plant 2 further comprises at least one dampener 22 with an adjustable dampening performance in order to dampen the paper web 10 and thereby adjust a moisture content (i.e. paper moisture content) of the paper web 10. During the dampening, the paper web 10 also swells, and thus the print gets larger. In the exemplary embodiment of FIG. 2, three such dampeners 22 are shown. In FIG. 2, all dampeners 22 are arranged downstream of the dryers 18, 20 and are therefore also referred to as re-dampeners. Each dampener 22 has, for example, at least one spray bar which extends transversely to the conveying direction and in particular over an entire width of the paper web 10 (i.e. perpendicular to the plane of the drawing in FIG. 2) and sprays water onto it during operation.

During the operation of the printing plant 2, an actual shrinkage and an actual moisture content are now determined for the paper web 10 and a setpoint shrinkage and a setpoint moisture content are specified, and the shrinkage and the moisture content are regulated to the setpoint shrinkage and the setpoint moisture content by adjusting the drying performance and the dampening performance depending on the actual shrinkage and the actual moisture content. In other words, by adjusting the drying and dampening performance, the shrinkage and the moisture content are adjusted during operation.

The setpoint shrinkage and the setpoint moisture content (controlled variables) are part of the configuration data and are therefore determined based on the job data or are already included in the job data themselves. The setpoint shrinkage and the setpoint moisture are job specific and are therefore changed accordingly if there is a change of job. In this case, the higher-level control unit 14 specifies the setpoint shrinkage and the setpoint moisture content for each job and transmits these to the machine controller, which then uses them to regulate the shrinkage and the moisture content and, for this purpose, controls the dryers 18, 20 and the dampener 22.

The actual shrinkage indicates how much the paper web 10 has shrunk after drying. The actual shrinkage is determined inline with a corresponding sensor, here with a plurality of web width sensors 24, 26, 28, which are arranged downstream of the printing unit 8. In the exemplary embodiment of FIG. 2, the actual shrinkage is determined by measuring a web width (perpendicular to the conveying direction) of the paper web 10 downstream of the dryers 18, 20 and comparing it with a web width upstream of the printing unit 8. The actual shrinkage is therefore actually a transverse shrinkage. In FIG. 2, the web width before the printing unit 8 is, by way of example, measured analogously using a web width sensor 30 upstream of the printing unit 8. The two web widths before and after the printing unit 8 are compared for example by considering a difference between the web widths in relation to the web width before the printing unit 8.

Alternatively or additionally, the actual shrinkage of the paper web 10 is determined by optically measuring the shrinkage of print image marks on the paper web 10 downstream of the dryers 18, 20. In FIG. 2, for this purpose an optical camera system 52, 54 is shown which optically records the print image and the print image marks contained therein and calculates a deviation between the setpoint and actual shrinkage from the job data. In FIG. 2, two possible positions for the camera system 52, 54 are shown, of which either only one or both are implemented at the same time. The use of two camera systems 52, 54 as shown in FIG. 2 enables both an inspection of the print image downstream of the printing unit 8 and an inspection of the varnish print image downstream of the varnish printing unit 46. The camera system 52 located further upstream (installation position 1) enables a particularly short control path, e.g. in the case of a splice. The camera system 54 located further downstream (installation position 2), on the other hand, is expediently active in controlled operation (also known as normal operation), since this position is particularly close to the winder 32 and thus best displays the finished print image.

By default, in the present case the actual shrinkage is determined with the web width sensor 28 at the end of the printing plant 2, immediately before a winder 32, or in the case of FIG. 1 outside thereof, e.g. along the transfer path 34 or within the corrugated cardboard plant 4, i.e. generally when the paper web 10 is not being further processed by the printing plant 2. By means of a shrinkage regulator, the drying performance of the dryers 18, 20 is regulated with the setpoint shrinkage as the reference variable and the actual shrinkage as the control variable.

As already mentioned, in the exemplary embodiment shown the actual shrinkage is determined as standard with the web width sensor 28, which is arranged as far downstream of the printing unit 8 as possible. Differing from this, in the case of a splice the actual shrinkage is determined with one of the web width sensors 24, 26, which are arranged upstream of the web width sensor 28 and thus closer to the printing unit 8. This reduces the web path from the printing unit 8 to the web width sensor 24, 26, 28.

In order to regulate the moisture content, the actual moisture content is determined analogously to the shrinkage, which indicates how moist the paper web 10 is after dampening. The determination of the actual moisture content is also carried out inline here. For this purpose, an appropriate sensor is used, here a moisture sensor 36, which is arranged downstream of the printing unit 8 and also downstream of all the dampeners 22. Analogous to the measurement of the actual shrinkage, the actual moisture content is preferably determined at the end of the printing plant 2 or even outside of it. By means of a moisture controller, the dampening performance of the dampener 22 is then regulated with the setpoint moisture content as the reference variable and the actual moisture content as the controlled variable.

In this case, the drying performance and dampening performance are regulated in such a way that the shrinkage is kept constant and the moisture content is kept greater than or equal to a minimum moisture content. This is maintained in inline operation and at variable web speeds, both within the same job (i.e. with constant job data) and with varying job data. The shrinkage is controlled in such a way that the actual shrinkage lies within a tolerance range of, for example, −/−0.5 to 1% of the setpoint shrinkage and around it. The moisture content is regulated in such a way that the actual moisture content corresponds to at least a minimum moisture content of e.g. 5%. The tolerance range and the minimum moisture content are specified for example by means of the higher-level control unit 14. If the tolerance range is exceeded or the minimum moisture content is undershot, a warning is issued in each case. The dampening performance is increased up to a maximum value that depends on the paper type and grammage before the warning is issued. In this case, the regulation of the shrinkage is limited by a minimum value for the dryer performance, so that this performance is not reduced arbitrarily far and a minimum level of drying is ensured. The minimum value depends on the web speed, the paper type and the amount of ink applied.

As an option to the previously mentioned components printing unit 8, dryer 18, 20 and dampener 22, the printing system 2 in FIG. 2 has one or more further components which serve to realize various production modes and/or further support drying and/or dampening.

Thus, the printing plant 2 shown in FIG. 2 has a primer application unit 38 for applying a primer to the paper web 10. The primer application unit 38 is arranged upstream of the printing unit 8 so that the primer is applied before printing. Thanks to the primer application unit 38, the printing plant 2 now has production modes with and without primer (application). Downstream of the primer application unit 38 and upstream of the printing unit 8, the printing plant 2 has a dryer 40, here a hot air dryer, which is also referred to as a primer dryer, for drying the primer. This dryer is primarily active for jobs that include primer application.

In addition, the printing plant 2 in FIG. 2 has a varnish application unit 42 for applying a varnish (i.e. for varnishing) to the paper web 10. The varnish application unit 42 is arranged downstream of the printing unit 8 so that the varnish is applied after printing and thus over the print. Due to the varnish application unit 42, the printing plant 2 now has production modes with and without varnish application. Downstream of the varnish application unit 42 and upstream of the printing unit 8, the printing plant 2 has a dryer 44, here a hot air dryer, which is also referred to as a varnish dryer, for drying the varnish. This dryer 44 is only active for jobs that include varnish application. In the present case, one of the dampeners 22 is arranged upstream of the varnish application unit 42 and another of the dampeners 22 is arranged downstream of the varnish dryer 44.

In addition, the printing plant 2 in FIG. 2 has a varnish printing unit 46, here a digital printing unit for varnish, for printing a varnish onto the paper web 10. The varnish printing unit 46 is arranged downstream of the printing unit 8 so that the varnish is printed after printing and thus over the printing. The varnish printing unit 46 is also arranged downstream of the varnish application unit 42. Thanks to the varnish printing unit 46, the printing plant 2 now has production modes with and without varnish printing. Downstream of the varnish printing unit 46, here the printing plant 2 has, analogously to the printing unit 8, a plurality of dryers 48, 50 for drying the varnish, namely two IR dryers 48 and two hot air dryers 50, each also referred to as varnish printing dryers. These dryers 48, 50 are only active for jobs that include varnish printing. One of the dampeners 22 is arranged downstream of the varnish printing unit 46 and the varnish printing dryers 48, 50.

The primer dryer 40, the varnish dryer 44 and the varnish print dryers 48, 50 are not necessarily used in the regulation, but are activated or deactivated independently depending on the required production mode. However, if one or more of these dryers 40, 44, 48, 50 are active, there will be a change in shrinkage and a reduction in moisture content, which will be automatically compensated for by the regulation system. If the primer dryer 40 is activated, pre-drying reduces the subsequent print image shrinkage while the ink drying settings remain the same.

The web width sensor 30 described above for measuring the web width before the printing unit 8 is arranged downstream of the primer application unit 38 and also downstream of the primer dryer 40. Downstream of the printing unit 8, the web width is measured at a plurality of measuring points, as already described, in each case by one of the web width sensors 24, 26, 28. A first measuring point is located downstream of the dryers 18, 20 and upstream of the varnish application unit 42. A second measuring point is located between the varnish application unit 42 and the varnish printing unit 46 and downstream of the varnish dryer 44. A third measuring point is located at the end of the printing plant 2, downstream of the varnish printing unit 46 and downstream of the varnish printing dryers 48, 50. The web width sensors 24, 26 are arranged at the first and second measuring points, respectively, in order to determine the actual shrinkage in the case of a splice. The web width sensor 28 is then arranged at the third measuring point for the determination of the actual shrinkage as standard.

Rapid changes in track speed pose a particular challenge for the regulation. Therefore, in the exemplary embodiment shown start values are stored for the drying performance and the dampening performance for each of a plurality of intervals of the web speed (e.g. as part of the job data) and when the web speed changes from a first interval to a second interval, the start values for the second interval are set first and then the shrinkage and moisture content are regulated based on these. Thus, if the web speed is changed so much that it falls into a different interval with different start values, these start values are set in order to avoid having to wait for the regulation, and to react better.

Similar to the web speed, the procedure here is also followed in the event of a large change in the setpoint shrinkage, e.g. in the event of a corresponding change of job. For this purpose, if the setpoint shrinkage is changed by a value that exceeds a predefined limit, the drying performance and the dampening performance are changed once (i.e. initially when the setpoint shrinkage is changed) by a predefined value in each case and then the shrinkage and the moisture content are regulated based on this. In this way, the regulation system is initially supported in adapting to the suddenly new setpoint shrinkage.

In addition, the regulation system is also relieved here by the fact that a compensation factor is already predefined with the job data in order to print the print enlarged in comparison with a setpoint dimension, so that a certain amount of shrinkage is permitted and does not have to be compensated for by the regulation. The print is therefore deliberately made larger and then shrinks to the setpoint size through shrinkage in printing plant 2. The regulation then compensates only or at least predominantly for dynamic changes, e.g. in the web speed or differences in the base paper. The printing unit 8 prints the print correspondingly larger according to the compensation factor, so that ultimately the starting conditions for the regulation are adjusted depending on the job in order to accommodate the regulation. The compensation factor depends, for example, on the other job data, e.g. paper type, grammage, production mode (with/without primer, varnish, varnish printing).

Since the job data for the new job are usually already known when the job changes while the current job is still being processed, the job data of the new job are used for predictive controlling of the dryers 18, 20 and dampener 22. Especially when the new job contains a quality change and, in contrast to the current job, requires an additional primer, varnish and/or varnish print, the primer dryer 40, the varnish dryer 44 or the varnish print dryers 48, 50 are preheated accordingly during the current job so that the required drying performance is available when the new job begins. The resulting changes in shrinkage and moisture content during the current application are automatically compensated for by the regulation.

In the present case, the combination of IR dryers 18 and hot air dryers 20 is used to activate the IR dryers 18 as a substitute during a heating-up phase of the hot air dryers 20 in the event of a request for an increase in drying performance by the regulation system, e.g. in the event of a corresponding change of job, in order to meet this request. The procedure described is used, for example, if the current job specifies a slow web speed, due to which the drying performance is reduced in order to reduce shrinkage and increase the moisture content. When the web speed is increased, the IR dryers 18 initially compensate for the reduced drying performance of the hot air dryers 20 until the latter have again reached the required drying performance.

In some cases it is advantageously possible to increase the range of possible web speeds by pre-drying the paper web 10 before printing. Therefore, in a suitable design, the printing plant 2 has a pre-dryer 40 to pre-dry the paper web 10 before printing. The primer dryer 40 already described is used as the pre-dryer 40 in FIG. 2, by way of example.

### LIST OF REFERENCE SIGNS

2 printing plant
4 corrugated cardboard plant
6 combination
8 printing unit
10 paper web
12 print head
14 higher-level control unit
16 corrugated cardboard
18 dryers, print dryers, IR dryers
20 dryers, print dryers, hot air dryers
22 dampener
24 web width sensor (downstream of the printing unit, first measuring point)
26 web width sensor (downstream of the printing unit, second measuring point)
28 web width sensor (downstream of the printing unit, third measuring point)
30 web width sensor (upstream of the printing unit)
32 winder
34 overpass
36 moisture sensor
38 primer application unit
40 dryers, hot air dryers, primer dryers
42 varnish application unit
44 dryers, hot air dryers, varnish dryers
46 varnish printing unit
48 dryers, IR dryers, varnish printing dryers
50 dryers, hot air dryers, varnish printing dryers
52 camera system
54 camera system

1. Method for inline operation of a printing plant,
wherein the printing plant has a printing unit for printing a paper web according to a predefined job with predefined job data,
wherein the paper web is conveyed through the printing plant at a web speed,
wherein the printing plant has at least one dryer with an adjustable drying performance in order to dry the paper web, as a result of which the paper web experiences shrinkage,
wherein the printing plant has at least one dampener with an adjustable dampening performance in order to dampen the paper web and thereby adjust a moisture content of the paper web,
wherein an actual shrinkage and an actual moisture content are determined for the paper web and a setpoint shrinkage and a setpoint moisture content are predefined,
wherein the shrinkage and the humidity are regulated to the setpoint shrinkage and the setpoint moisture content by adjusting the drying performance and the dampening performance depending on the actual shrinkage and the actual moisture content.

2. Method according to claim 1,
wherein the paper web is fed to a corrugated cardboard plant after printing,
wherein the web speed is predefined by the corrugated cardboard plant and varies over time.

3. Method according to claim 1,
wherein the actual shrinkage of the paper web is determined by measuring a web width of the paper web downstream of the dryer and comparing it with a web width upstream of the printing unit or by optically measuring a shrinkage of print image marks on the paper web.

4. Method according to claim 1,
wherein the actual shrinkage is determined with a first sensor which is arranged downstream of the printing unit and at the end of the printing plant or outside thereof, except in the case of a splice, in which case the actual shrinkage is determined with a second sensor which is arranged upstream of the first sensor.

5. Method according to claim 1,
wherein the shrinkage is regulated such that the actual shrinkage lies within a tolerance range around the setpoint shrinkage,
wherein the moisture content is regulated such that the actual moisture content corresponds to at least a minimum moisture content.

6. Method according to claim 1,
wherein the regulation of the shrinkage is limited by a minimum value for the dryer performance so that a minimum degree of drying is ensured.

7. Method according to claim 1,
wherein start values for the drying performance and the dampening performance are stored for a plurality of intervals of the web speed,
wherein when the web speed changes from a first interval to a second interval, the start values for the second interval are first set and then the shrinkage and moisture content are regulated based on these.

8. Method according to claim 1,
wherein if the setpoint shrinkage changes by a value that exceeds a predefined limit, the drying performance and the dampening performance are changed once by a predefined value in each case and then the shrinkage and moisture are regulated based on this.

9. Method according to claim 1,
wherein when changing from a current job to a new job and if the new job requires an additional coating, a dryer for this coating is already preheated during the current job.

10. Method according to claim 1,
wherein the dryer is a hot air dryer and the printing plant has in addition to this an IR dryer to dry the paper web,
wherein, if an increase in the drying performance is requested by the regulation system, the IR dryer is activated as a substitute during a heating phase of the dryer in order to meet this request.

11. Method according to claim 1,
wherein the printing plant has a pre-dryer to pre-dry the paper web before printing.

12. Method according to claim 1,
wherein the regulation is relieved by the fact that a compensation factor is already predefined with the job data in order to print the print enlarged in comparison with a setpoint dimension, so that a certain amount of shrinkage is permitted and does not have to be compensated for by the regulation.

13. Printing plant or combination of such a plant and a corrugated cardboard plant, wherein the printing plant is designed to carry out a method according to claim 1.
